(19) United States
(12) Patent Application Publication
(10) Pub. No.: US 2026/0335156 A1
(43) Pub. Date: Oct. 29, 2026

(54) Inflatable Patient-Turning Device

(71) Applicant: Michelle Salvatera, Oak Lawn, IL (US)

(72) Inventor: Michelle Salvatera, Oak Lawn, IL (US)

(21) Appl. No.: 19/186,787

(22) Filed: Apr. 23, 2025

(51) Int. Cl. A61G 7/00; A61G 7/10

(52) U.S. Cl. CPC A61G 7/001; A61G 7/1021

(57) ABSTRACT

An inflatable patient-turning device is provided. The device is designed to assist caregivers in safely and efficiently repositioning patients while reducing physical strain and minimizing the risk of patient and caregiver injury. The device comprises a top sheet integrated with inflatable wedges that facilitate lateral turning, postural adjustments, and pressure redistribution. The top sheet is waterproof, breathable, and may include an anti-microbial coating for enhanced hygiene, while fasteners ensure secure attachment to various bed sizes. The inflatable wedges are designed with durable, leak-proof construction and allow selective inflation to achieve desired repositioning angles. An air compressor, controlled via a handheld device, inflates and deflates the wedges through tubing concealed within the top sheet, ensuring ease of operation.

### FIELD OF THE INVENTION

The present invention relates generally to the field of patient-turning devices. More specifically, the present invention relates to a top sheet with integrated inflatable wedges controlled by a handheld device for lateral turning, postural adjustments, and pressure redistribution of a bedridden patient. Accordingly, the present disclosure makes specific reference thereto. Nonetheless, it is to be appreciated that aspects of the present invention are also equally applicable to other like applications, devices, and methods of manufacture.

### BACKGROUND

Bedridden patients require regular repositioning to prevent health complications such as pressure ulcers, respiratory issues, and circulatory problems. Without consistent turning, prolonged pressure on certain areas of the body can lead to tissue breakdown, resulting in pressure sores that are difficult and costly to treat. Additionally, poor positioning can hinder respiratory function and contribute to the development of pneumonia or other pulmonary conditions. In healthcare settings, such as hospitals or long-term care facilities, caregivers often face challenges when repositioning patients, particularly when staff numbers are limited or when patients have mobility restrictions. The manual effort required to turn patients can lead to physical strain and injury among caregivers, further exacerbating staffing issues. This issue is compounded in cases involving bariatric patients or individuals with fragile health, where precise and frequent adjustments are critical to avoid complications. Current solutions rely heavily on manual labor or complex mechanical systems that may not be feasible in every care environment, highlighting the need for an efficient and ergonomic alternative.

Therefore, there exists a long-felt need in the art for an inflatable patient-turning device that reduces the physical strain on caregivers during patient repositioning. There also exists a long-felt need in the art for an inflatable patient-turning device that minimizes the risk of patient injury during lateral turning and postural adjustments. Moreover, there exists a long-felt need in the art for an inflatable patient-turning device that enhances operational efficiency and hygiene in healthcare settings by incorporating advanced material and design features.

The subject matter disclosed and claimed herein, in one embodiment thereof, comprises an inflatable patient-turning device. The device is designed to assist caregivers in safely and efficiently repositioning patients while reducing physical strain and minimizing the risk of patient and caregiver injury. The device comprises a top sheet integrated with inflatable wedges that facilitate lateral turning, postural adjustments, and pressure redistribution. The top sheet is waterproof, breathable, and may include an anti-microbial coating for enhanced hygiene, while fasteners ensure secure attachment to various bed sizes. The inflatable wedges are designed with durable, leak-proof construction and allow selective inflation to achieve desired repositioning angles. An air compressor, controlled via a handheld device, inflates and deflates the wedges through tubing concealed within the top sheet, ensuring ease of operation. Adjustable safety straps provide secure and comfortable patient stabilization, and the system supports a wide range of clinical needs, including pressure ulcer prevention and hygiene maintenance.

In this manner, the inflatable patient-turning device of the present invention accomplishes all the forgoing objectives and provides at least two of inflatable wedges attached to a waterproof, antimicrobial top sheet that is compatible with standard healthcare beds. The device enables caregivers to reposition patients through selective inflation and deflation of the wedges, which feature non-slip textures and ergonomic angles designed for safe and effective turning. The integration of a handheld controller and air compressor system simplifies operation, allowing caregivers to achieve precise positioning with minimal effort. As a result, the device addresses the physical demands on caregivers and reduces injury risk.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an inflatable patient-turning device designed to assist caregivers in repositioning patients safely and efficiently while reducing physical strain. The device is comprised of a top sheet integrated with inflatable wedges that facilitate lateral turning, postural adjustments, and pressure redistribution without manual lifting. This device addresses clinical needs such as pressure ulcer prevention, respiratory therapy, and hygiene maintenance, making it suitable for various healthcare settings.

The top sheet is configured for compatibility with multiple bed sizes and is waterproof to protect against moisture. Some embodiments include perforations for breathability and an anti-microbial coating to inhibit microbial growth. The sheet is secured to beds using fasteners positioned along its edges to prevent displacement.

The preferred embodiment includes at least two inflatable wedges—an outer wedge and an inner wedge. The wedges are constructed from medical-grade thermoplastic polyurethane with oleophobic coatings for easy cleaning. The wedges may have non-slip textured surfaces to enhance patient stability and comfort during use. Double-stitched seams and additional bonding ensure durability and leak resistance. The wedges inflate to form a hypotenuse edge at approximately 60 degrees, with alternative angles available for specific needs. The opposing orientations of the wedges enable selective inflation to reposition patients as required.

Safety straps with adjustable fasteners and cushioning materials secure the patient during use, minimizing skin irritation and pressure-related injuries. Inflation and deflation of the wedges are controlled via a handheld controller connected to an air compressor. The controller includes buttons for inflation, deflation, and wedge selection.

The wedges are connected to the compressor through tubing, concealed within the top sheet to prevent tangling and accidental disconnection. The tubing features quick-disconnect couplings with anti-backflow valves for easy maintenance.

The device operates by securing the top sheet to a bed, positioning a patient on the deflated wedges, and using the handheld controller to inflate selected wedges. This process gently repositions or elevates the patient to meet clinical needs, such as lateral turning or pressure redistribution, before deflating the wedges to return the patient to a neutral position.

Accordingly, the inflatable patient-turning device of the present invention is particularly advantageous as it provides a series of inflatable wedges attached to a waterproof, antimicrobial top sheet that is compatible with standard healthcare beds. The device enables caregivers to reposition patients through selective inflation and deflation of the wedges, which feature non-slip textures and ergonomic angles designed for safe and effective turning. The integration of a handheld controller and air compressor system simplifies operation, allowing caregivers to achieve precise positioning with minimal effort. As a result, the device addresses the physical demands on caregivers and reduces injury risk.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an inflatable patient-turning device of the present invention with the outer wedges inflated in accordance with the disclosed architecture;

FIG. 2 illustrates a perspective view of one potential embodiment of an inflatable patient-turning device of the present invention with the inner wedges inflated in accordance with the disclosed architecture;

FIG. 3 illustrates a perspective view of one potential embodiment of an inflatable patient-turning device of the present invention with the outer wedges inflated while being used to turn a patient in accordance with the disclosed architecture; and

FIG. 4 illustrates a flowchart of a method of using one potential embodiment of an inflatable patient-turning device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an inflatable patient-turning device that reduces the physical strain on caregivers during patient repositioning. There also exists a long-felt need in the art for an inflatable patient-turning device that minimizes the risk of patient injury during lateral turning and postural adjustments. Moreover, there exists a long-felt need in the art for an inflatable patient-turning device that enhances operational efficiency and hygiene in healthcare settings by incorporating advanced material and design features.

The present invention, in one exemplary embodiment, is comprised of an inflatable patient-turning device designed to assist caregivers in repositioning patients safely and efficiently while reducing physical strain. The device is comprised of a top sheet integrated with inflatable wedges to facilitate lateral turning, postural adjustments, and pressure redistribution without manual lifting. It addresses clinical applications such as pressure ulcer prevention, respiratory therapy, and hygiene maintenance, making it suitable for diverse healthcare settings.

The top sheet is designed for compatibility with various bed sizes and is waterproof to protect against moisture. Certain embodiments include perforations for breathability and an antimicrobial coating to inhibit microbial growth. Fasteners positioned along the edges secure the sheet to the bed, preventing displacement during use.

The preferred embodiment includes three inflatable wedges—two outer wedges and one inner wedge. These wedges are constructed from medical-grade thermoplastic polyurethane with oleophobic coatings for ease of cleaning. Non-slip textured surfaces enhance patient stability and comfort, while double-stitched seams and additional bonding provide durability and leak resistance. The wedges inflate to form a hypotenuse edge at approximately 60 degrees, with other angles available for specific requirements. Opposing wedge orientations allow selective inflation for precise patient repositioning.

Safety straps with adjustable fasteners and cushioning materials secure the patient during use, reducing the risk of skin irritation and pressure-related injuries. Inflation and deflation of the wedges are controlled through a handheld controller connected to an air compressor. The controller is equipped with buttons for inflation, deflation, and wedge selection.

The wedges are connected to the air compressor via tubing concealed within the top sheet to prevent tangling and accidental disconnection. Quick-disconnect couplings with anti-backflow valves are integrated into the tubing to facilitate easy maintenance.

Operation of the device involves securing the top sheet to the bed, positioning the patient on the deflated wedges, and using the handheld controller to inflate selected wedges. This process gently repositions or elevates the patient to meet clinical needs, such as lateral turning or pressure redistribution, before deflating the wedges to return the patient to a neutral position.

The inflatable patient-turning device provides an efficient solution by combining inflatable wedges with a waterproof, antimicrobial top sheet compatible with standard healthcare beds. The device enables caregivers to reposition patients using selective inflation and deflation of wedges featuring non-slip textures and ergonomic angles for safe, effective turning. The integration of a handheld controller and air compressor system streamlines operation, enabling precise positioning while reducing caregiver effort and minimizing injury risk.

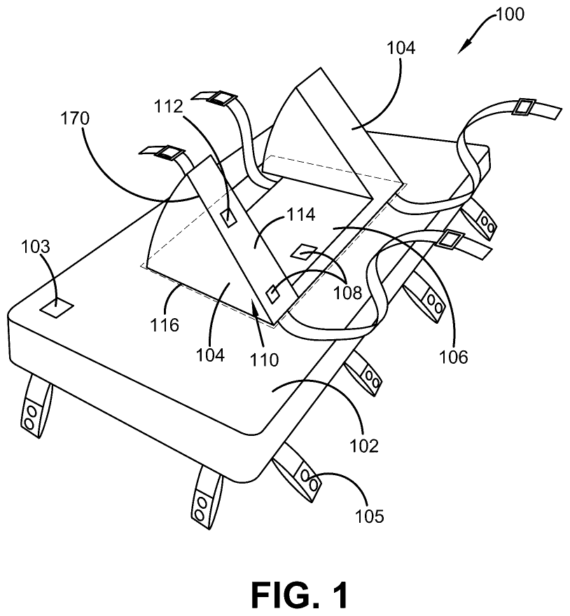

Referring initially to the drawings, FIG. 1 illustrates a perspective view of one potential embodiment of an inflatable patient-turning device 100 of the present invention with the outer wedges inflated in accordance with the disclosed architecture. The inflatable patient-turning device 100 is designed to assist caregivers in repositioning/turning patients in a safe, efficient, and ergonomic manner. The device 100 is comprised of a series of inflatable wedges 104,106 integrated into a top sheet 102, wherein the wedges 104,106 enable lateral turning, postural adjustments, and pressure redistribution without the need for manual patient lifting. This functionality significantly reduces the physical strain on caregivers, minimizes the risk of patient injury, and supports a wide range of clinical needs, including but not limited to pressure ulcer prevention, respiratory therapy, and hygiene maintenance during care routines. The device 100 is particularly suitable for use in hospitals, long-term care facilities, and other healthcare settings where regular patient repositioning is required.

The top sheet 102 is configured to be compatible with various bed sizes, including but not limited to standard hospital beds, bariatric beds, and specialized care beds. The top sheet 102 is preferably waterproof to protect the underlying mattress and patient from moisture penetration. In one embodiment, the material of the top sheet 102 is perforated to enhance breathability and to allow for improved airflow to the patient's skin while maintaining the waterproof properties. To further improve hygiene and infection control, the sheet 102 may include an anti-microbial coating 103. This coating may involve a silver-ion treatment or other biocidal agents that are effective in inhibiting the growth of bacteria, mold, and fungi. The top sheet 102 may be secured to a bed using a fastener 105 such as but not limited to snap loops, hook-and-loop fasteners, or elastic straps. The fasteners 105 are positioned strategically along the edges of the sheet 102 to ensure a secure attachment to/around a bed, preventing movement or displacement during use.

In the preferred embodiment, the device 100 is comprised of at least two inflatable wedges, an outer wedge 104 and an inner wedge 106. In another embodiment, the device 100 includes a pair of outer wedges 104 and an inner wedge 106 positioned between the outer wedges 104. The wedges 104, 106 are constructed from medical-grade thermoplastic polyurethane (TPU) that may be coated with an oleophobic layer 108 to repel oils, bodily fluids, and other contaminants, facilitating easy cleaning and maintenance. The external surface 110 of the wedges 104, 106 may feature embossed non-slip textures 112, which could include patterned ridges, raised nodes, or other designs. The textures are designed to reduce friction between the wedges 104, 106 and the patient's clothing or skin, thereby enhancing both comfort and stability during repositioning.

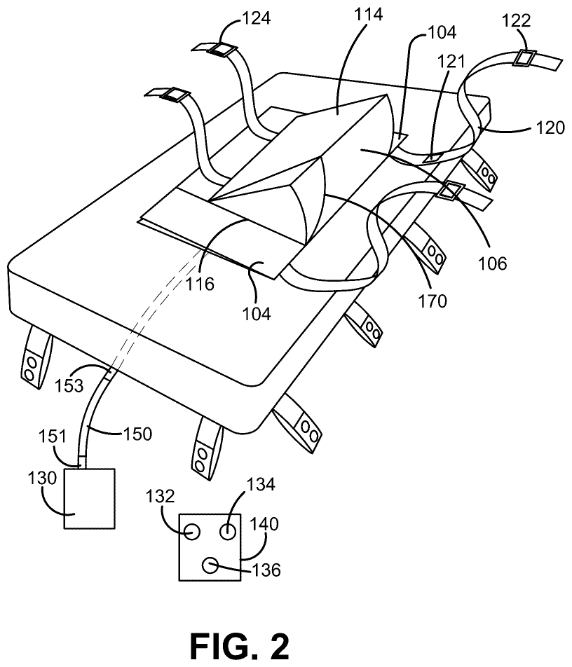

The construction of the wedges 104, 106 incorporates double-stitched seams 170, which may be further bonded using heat sealing or ultrasonic welding to ensure a leak-proof and durable structure. The wedges 104, 106 are designed to inflate and form a hypotenuse edge 114 at an angle of approximately 60 degrees relative to a base edge 116. However, alternative embodiments may utilize wedges with differing angles to accommodate a variety of patient body types, medical conditions, or specific clinical needs. The hypotenuse edge 114 of the outer wedges 104 is preferably oriented in the opposite direction from the hypotenuse edge 114 of the inner wedge 106. This opposing orientation allows the selective inflation of either the outer wedges 104 or the inner wedge 106 (as seen in FIG. 1 and FIG. 2), enabling caregivers to reposition the patient in a desired direction (e.g., left or right turn).

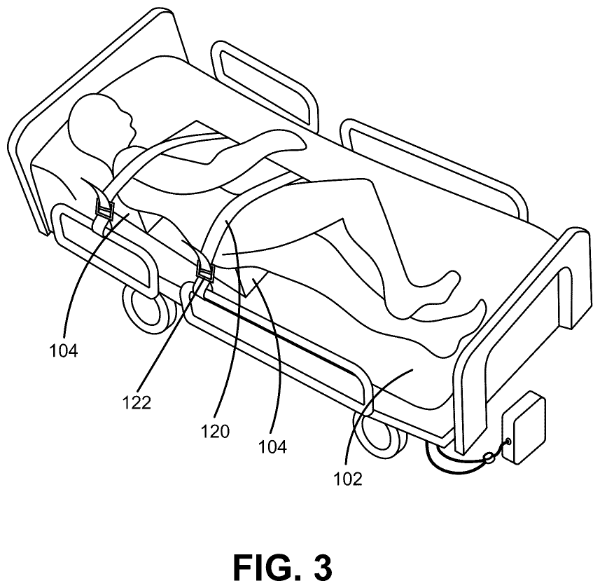

During operation, a patient may be secured to the wedges 104, 106 (without inhibiting turning movement) using at least one safety strap 120, as seen in FIG. 3. The safety strap 120 is preferably adjustable and secured using a fastener 122, such as but not limited to an adjustable G-buckle. To prevent skin irritation and pressure-related injuries, the straps 120 may be comprised of a padding 121 with pressure-distributing materials such as memory foam, gel inserts, or similar cushioning materials. The length of the straps 120 may be further adjusted using additional fasteners 124, which could include hook-and-loop mechanisms or sliding buckles to ensure a customizable and secure fit for patients of varying sizes. In one embodiment, the strap 120 is secured to the bed rails prior to inflation of the wedges 104,106.

The inflation and deflation of the wedges 104, 106 is managed by an air compressor 130. The compressor 130 is controlled via a handheld controller 140, which includes multiple user-friendly buttons to facilitate operation. The buttons may include a deflation button 132, an inflation button 134, and a selector button 136 that allows the caregiver to choose between inflating or deflating the outer wedges 104 or the inner wedge 106.

The wedges 104, 106 are connected to the compressor 130 through at least one tubing 150, which may be comprised of silicone or polyvinyl chloride (PVC). The tubing 150 is preferably concealed within the layers of the top sheet 102 to minimize the risk of tangling or accidental disconnection during use. The tubing 150 may also feature quick-disconnect couplings 151 equipped with anti-backflow valves 153 to enable easy maintenance or component replacement without compromising air pressure integrity.

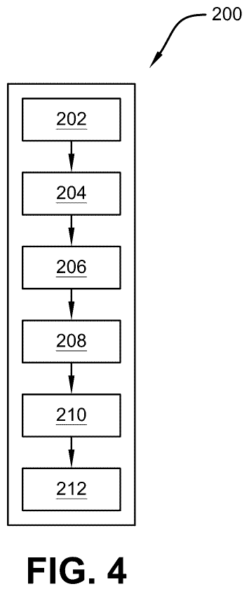

The present invention is also comprised of a method of using 200 the inflatable patient-turning device 100, as illustrated in FIG. 4. First, a device 100 is provided, wherein the device 100 is comprised of a top sheet 102, at least one pair of outer wedges 104, at least one inner wedge 106, at least one air compressor 130, and a handheld controller 140 [Step 202]. Then, the top sheet 102 is positioned over a bed and secured using a plurality of fasteners 105, such as snap loops or hook-and-loop fasteners, to ensure proper alignment and attachment to the mattress [Step 204]. Next, a patient is placed onto the top sheet 102 on the deflated edges 104,106, and at least one safety strap 120 is secured around the patient using an adjustable fastener 122 to ensure that the patient is safely held in place during operation [Step 206]. Once the patient is secured, the handheld controller 140 is used to operate the air compressor 130. The user selects a desired wedge, either the outer wedges 104 (as seen in FIG. 1) or the inner wedge 106 (as seen in FIG. 2), for inflation by pressing the selector button 136 on the controller 140. Then, the inflation button 134 is activated, causing air to flow through the tubing 150 and into the selected wedge, inflating the wedge to the desired angle and position [Step 208]. As a result, the inflated wedge 104, 106 gently repositions the patient laterally or elevates a specific portion of the patient's body, depending on the clinical need or caregiver's objective [Step 210]. Once the repositioning is complete, the deflation button 132 on the handheld controller 140 is pressed, causing the selected wedge 104, 106 to deflate and return the patient to a neutral position on the mattress [Step 212]. This inflation and deflation process can be repeated as needed to perform additional lateral repositioning, postural adjustments, or pressure redistribution.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “inflatable patient-turning device” and “device” are interchangeable and refer to the inflatable patient-turning device 100 of the present invention.

Notwithstanding the forgoing, the inflatable patient-turning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the inflatable patient-turning device 100 as shown in the FIGS. are for illustrative purposes only, and that many other sizes and shapes of the inflatable patient-turning device 100 are well within the scope of the present disclosure. Although the dimensions of the inflatable patient-turning device 100 are important design parameters for user convenience, the inflatable patient-turning device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An inflatable patient-turning device comprising:
a top sheet comprised of a fastener;
an outer wedge attached to the top sheet, the pair of inflatable outer wedges facing a first direction;
a safety strap;
an inflatable inner wedge, the inflatable inner wedge facing a second direction;
an air compressor configured to inflate and deflate the pair of inflatable outer wedges and the inflatable inner wedge;
a handheld controller operatively connected to the air compressor, the handheld controller comprising an inflation button, a deflation button, and a selector button to control the inflation or deflation of selected the pair of inflatable outer wedges and the inflatable inner wedge; and
a tubing connecting the pair of inflatable outer wedges and the inflatable inner wedge to the air compressor.

2. The inflatable patient-turning device of claim 1, wherein the top sheet is waterproof.

3. The inflatable patient-turning device of claim 1, wherein the top sheet is comprised of an anti-microbial coating.

4. The inflatable patient-turning device of claim 1, wherein the fastener is comprised of a snap loop.

5. The inflatable patient-turning device of claim 1, wherein the inflatable outer wedge and the inflatable inner wedge is comprised of a non-slip texture.

6. The inflatable patient-turning device of claim 1, wherein the safety strap is comprised of a padding.

7. The inflatable patient-turning device of claim 1, wherein the air compressor is configured to provide independent inflation and deflation of the inflatable outer wedge and the inflatable inner wedge.

8. The inflatable patient-turning device of claim 1, wherein the inflatable outer wedge is comprised of a first hypotenuse edge and a second hypotenuse edge that is angled at 60 degrees relative to a first bottom edge and a second bottom edge of the inflatable outer wedge.

9. The inflatable patient-turning device of claim 1, wherein the inflatable inner wedge is comprised of a third hypotenuse edge angled at 60 degrees relative to a third bottom edge of the inflatable inner wedge.

10. An inflatable patient-turning device comprising:
a top sheet comprised of a first fastener;
a pair of inflatable outer wedges attached to the top sheet, the pair of inflatable outer wedges facing a first direction;
a safety strap comprised of a second fastener;
an inflatable inner wedge positioned between the pair of inflatable outer wedges, the inflatable inner wedge facing a second direction;
an air compressor configured to inflate and deflate the pair of inflatable outer wedges and the inflatable inner wedge;
a handheld controller operatively connected to the air compressor, the handheld controller comprising an inflation button, a deflation button, and a selector button to control the inflation or deflation of selected the pair of inflatable outer wedges and the inflatable inner wedge; and
a tubing connecting the pair of inflatable outer wedges and the inflatable inner wedge to the air compressor.

11. The inflatable patient-turning device of claim 10, wherein the pair of inflatable outer wedges are comprised of a first hypotenuse edge and a second hypotenuse edge that are angled at 60 degrees relative to a first bottom edge and a second bottom edge of each of the pair of inflatable outer wedges.

12. The inflatable patient-turning device of claim 10, wherein the inflatable inner wedge is comprised of a third hypotenuse edge angled at 60 degrees relative to a third bottom edge of the inflatable inner wedge.

13. The inflatable patient-turning device of claim 10, wherein the inflatable inner wedge is comprised of an oleophobic layer.

14. The inflatable patient-turning device of claim 10, wherein the pair of inflatable outer wedges are comprised of an oleophobic layer.

15. The inflatable patient-turning device of claim 10, wherein the top sheet is perforated.

16. The inflatable patient-turning device of claim 10, wherein the fastener is comprised of a hook and loop fastener.

17. The inflatable patient-turning device of claim 10, wherein the first fastener is comprised of an elastic strap.

18. The inflatable patient-turning device of claim 10, wherein the second fastener is comprised of a G-buckle.

19. The inflatable patient-turning device of claim 10, wherein the safety strap is adjustable in length.

20. A method of using an inflatable patient-turning device, the method comprising the following steps:
providing an inflatable patient-turning device comprised of a top sheet, a pair of outer wedges, an inner wedge positioned between the pair of outer wedges, an air compressor, and a handheld controller;
positioning the top sheet over a bed and securing the top sheet to the bed using a fastener;
placing a patient onto the top sheet over the pair of outer wedges and the inner wedge while deflated and securing the patient using at least one safety strap;
selecting the pair of outer wedges or the inner wedge for inflation using a selector button on the handheld controller;
activating the air compressor using the inflation button to inflate the pair of outer wedges or the inner wedge;
repositioning the patient by inflating the pair of outer wedges or the inner wedge to a desired position; and
deflating the pair of outer wedges or the inner wedge using the deflation button to return the patient to a neutral position.
